(19) United States
(12) Patent Application Publication
(10) Pub. No.: US 2006/0168613 A1
(43) Pub. Date: Jul. 27, 2006

(54) Systems and processes for use in media and/or market research

(76) Inventors: Leslie A. Wood, Copake Falls, NY (US); Joan G. Fitzgerald, Arlington, VA (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 11/288,866

(22) Filed: Nov. 29, 2005

Related U.S. Application Data
(60) Provisional application No. 60/631,480, filed on Nov. 29, 2004.

(51) Int. Cl. H04N 7/16; G06F 3/00; G06F 13/00; H04H 9/00; H04N 5/445

(52) U.S. Cl. 725/11; 725/9; 725/46

(57) ABSTRACT

Processes and systems for use in media and market research are provided. In certain embodiments, predetermined media usage activities and/or purchasing activities are assigned to members of a household, for converting household level data to personal level data. In certain embodiments, reports are produced from various different datasets.

### RELATED APPLICATION

This application claims priority to U.S. provisional patent application Ser. No. 60/631,480, filed Nov. 29, 2004, which is hereby incorporated herein by reference in its entirety.

### FIELD OF THE INVENTION

The present invention relates to systems and processes for use in media and/or market research.

### BACKGROUND OF THE INVENTION

Consumers are exposed to a wide variety of media, including television, radio, print, outdoor advertisements (e.g., billboards) and other forms. Numerous surveys and, more recently, electronic devices are utilized to ascertain the types of media to which individuals and households are exposed. The results of such surveys and data acquired by electronic devices (e.g., ratings data) are currently utilized to set advertising rates and to guide advertisers as to where and when to advertise.

Radio and television audience estimates, as well as estimates of audiences for other media, provide a useful tool in assessing the value of advertising through such media. But they do not directly measure the effectiveness of the advertisements in influencing consumers to purchase the advertised product or service. In an attempt to overcome this problem, numerous different datasets pertaining to media exposure of consumers and the shopping and purchasing habits of consumers have been made available.

The various types of media and market research information identified above, as well as others not mentioned, are produced by different companies and usually are presented in different formats, concerning different time periods, different products, different media, etc. It is therefore desired to reconcile the data from multiple sources and/or representing different information in an accurate and meaningful way to derive information that is both understandable and useful.

In addition to the foregoing, various electronic devices (e.g., bar code scanners) are employed to track, among other things, consumer purchasing behavior, but such devices usually track activity only at the household level. Prior attempts to convert data at the household level to data at the person level have resulted in substantial inaccuracies. In one previously utilized conversion process, it is assumed that the household behavior or activity was carried out by each and every household member. Thus, if the data identifies that a household purchased a particular product, then such data is converted into data indicative that each person in the household had purchased the product. A second previously utilized conversion process assumes that only a single person with certain characteristics (i.e., female head of household) in the household had performed all of the reported behavior or activity. Thus, if a dataset includes data that indicates that a household purchased, for example, fifty identified items (e.g., data obtained from a barcode scanner panel), then that data is converted to data that indicates that only a single person had purchased every one of those fifty items. When a household does not include a person with the above-mentioned characteristics, then no person in the household is deemed to have made the purchases. In the case of tracking Internet usage, the process deems that all of the Internet usage was carried out by only a single person in the household.

The first process for converting household level data to person level data identified above overstates behaviors for households with multiple members. The second process sometimes understates behaviors, but more importantly introduces inaccuracies in the conversion since household behavior is generally carried out by multiple individuals, especially in large households. Additional inaccuracies are introduced in the conversion when the household member selected to have carried out all of the behavior had in fact carried out only a minimal amount of such behavior. Clearly, neither of these known processes are acceptable for many uses. It is therefore desired to overcome the inaccuracies introduced by the above-described data conversion techniques.

### SUMMARY OF THE INVENTION

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The terms “media data” and “media” as used herein mean data which is widely accessible, whether over-the-air, or via cable, satellite, network, internetwork (including the Internet), print, displayed, distributed on storage media, or by any other means or technique that is humanly perceptible, without regard to the form or content of such data, and including but not limited to audio, video, text, images, animations, databases, datasets, files, broadcasts, displays (including but not limited to video displays, posters and billboards), signs, signals, web pages and streaming media data.

The term “database” as used herein means an organized body of related data, regardless of the manner in which the data or the organized body thereof is represented. For example, the organized body of related data may be in the form of a table, a map, a grid, a packet, a datagram, a file, a document, a list or in any other form.

The term “dataset” as used herein means a set of data, whether its elements vary from time to time or are invariant, whether existing in whole or in part in one or more locations, describing or representing a description of, activities and/or attributes of a person or a group of persons, such as a household of persons, or other group of persons, and/or other data describing or characterizing such a person or group of persons, regardless of the form of the data or the manner in which it is organized or collected.

The term “correlate” as used herein means a process of ascertaining a relationship between or among data, including but not limited to an identity relationship, a correspondence or other relationship of such data to further data, inclusion in a dataset, exclusion from a dataset, a predefined mathematical relationship between or among the data and/or to further data, and the existence of a common aspect between or among the data.

The terms “purchase” and “purchasing” as used herein mean a process of obtaining title, a license, possession or other right in or to goods or services in exchange for consideration, whether payment of money, barter or other legally sufficient consideration, or as promotional samples. As used herein, the term “goods” and “services” include, but are not limited to, data.

The term “network” as used herein includes both networks and internetworks of all kinds, including the Internet, and is not limited to any particular network or inter-network.

The terms “first”, “second”, “primary” and “secondary” are used to distinguish one element, set, data, object, step, process, activity or thing from another, and are not used to designate relative position or arrangement in time, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate,” “communicating” and “communication” as used herein include both conveying data from a source to a destination, and delivering data to a communications medium, system, channel, device or link to be conveyed to a destination.

The term “processor” as used herein means processing devices, apparatus, programs, circuits, components, systems and subsystems, whether implemented in hardware, software or both, whether or not programmable and regardless of the form of data processed, and whether or not programmable. The term “processor” as used herein includes, but is not limited to computers, hardwired circuits, signal modifying devices and systems, devices and machines for controlling systems, central processing units, programmable devices, state machines, virtual machines and combinations of any of the foregoing.

The terms “storage” and “data storage” as used herein mean data storage devices, apparatus, programs, circuits, components, systems, subsystems and storage media serving to retain data, whether on a temporary or permanent basis, and to provide such retained data.

The terms “panelist,” “respondent” and “participant” are interchangeably used herein to refer to a person who is, knowingly or unknowingly, participating in a study to gather information, whether by electronic, survey or other means, about that person's activity.

The term “household” as used herein is to be broadly construed to include family members, a family living at the same residence, a group of persons related or unrelated to one another living at the same residence, and a group of persons living within a common facility, such as a fraternity house, an apartment or other similar structure or arrangement.

The term “activity” as used herein includes both active and passive activity, whether intentional or unintentional. Active activity includes, but is not limited to, purchasing conduct, shopping habits, viewing habits, computer and Internet usage, as well as other actions discussed herein. Passive activity includes, but is not limited to, exposure to media, and personal attitudes, awareness, opinions and beliefs.

The term “market activity” as used herein means activity within a market, whether physical or virtual (e.g., the Internet market), and includes, but is not limited to, purchasing, presence in commercial establishments, proximity to commercial establishments, and exposure to products or services.

The term “attribute” as used herein pertaining to a household member shall mean demographic characteristics, personal status data and data concerning personal activities, including, but not limited to, gender, income, marital status, employment status, race, religion, political affiliation, transportation usage, hobbies, interests, recreational activities, social activities, market activities, media activities, Internet and computer usage activities, and shopping habits.

In accordance with an aspect of the present invention, a process is provided for estimating which persons in a household engaged in predetermined media usage activities, media exposure activities and/or market activities attributed to the household. The process comprises providing household data representing a plurality of media usage activities, media exposure activities and/or market activities attributed to a household, providing individual member data representing an attribute of each of a plurality of household members, and separately assigning each of the plurality of media usage activities, media exposure activities and/or market activities to a respective one of the household members based on the individual member data.

In accordance with a further aspect of the present invention, a process of converting data within a dataset representative of activity of a household having a plurality of members resulting from media and/or market research studies to data representative of activity of household members is provided. The process comprises obtaining a first dataset identifying an activity of the household carried out during a predetermined period of time during a first study, the first dataset including data representing a total amount of the activity carried out by the household during the predetermined period of time; obtaining a second dataset comprising results of a survey of participants in the household, the second dataset containing data indicating an amount of the activity carried out by each participant during the predetermined period of time; for each of the household members who participated in the survey, producing data representing a determined amount of the activity carried out by the respective member during the predetermined period of time based upon the total amount of usage represented by data in the first dataset and the indicated amounts in the second dataset; and producing data identifying each household member who participated in the survey and data representing the determined amount of the activity carried out by each respective household member.

In accordance with another aspect of the present invention, a process of preparing a media and/or market research report from data included in a dataset of media and/or market research data is provided, the dataset including data records each pertaining to a corresponding participant in a media and/or market research activity and including participant related data representing at least one of the corresponding participant's attributes. The process comprises providing characteristics data defining a set of the participants to include in a media and/or market research report; providing behavior data defining a set of media usage activities, media exposure activities and/or market activities to include in the market research report; accessing data records from the dataset based on at least one of the characteristics data and the behavior data; and producing a media and/or market research report using data included in the accessed data records based on the characteristics data and the behavior data.

In accordance with a still further aspect of the present invention, a process of producing a report from datasets containing data from media usage, media exposure and/or market research studies, is provided. The process comprises obtaining a first dataset including data representative of at least a first activity of participants in a first study; obtaining a second dataset including data representative of at least a second activity of participants in a second study; identifying a characteristic for use in generating a report, the characteristic being one of the first activity and the second activity; identifying a behavior for use in generating the report, the behavior being the other of the first activity and the second activity; selecting participants for inclusion in the report based upon data from at least one of the first dataset and the second dataset indicating participants who carried out the identified characteristic; and including data in the report representing the identified behavior of the selected participants.

In accordance with yet a further aspect of the present invention, a process is provided for producing a report from datasets containing data representative of results of studies measuring different activity. The process comprises obtaining access to a plurality of datasets each including data representative of activity of participants in a respective study; identifying a characteristic for use in generating a report; selecting a first dataset from the plurality of datasets measuring activity of participants in the respective study corresponding to the identified characteristic for use in generating the report; selecting for inclusion in the report participants in the selected first dataset who, as indicated by the data of the selected first dataset, carried out the identified characteristic; identifying a behavior to integrate with the identified characteristic; selecting a second dataset from the plurality of datasets measuring activity of participants in the respective study corresponding to the identified behavior, the participants in the study corresponding to the selected first dataset also being participants in the study corresponding to the selected second dataset; and producing a report including data representative of the participants selected for inclusion in the report and data representative of the activity of the participants selected for inclusion measured in the study corresponding to the selected second dataset.

In accordance with yet another aspect of the present invention, a process is provided for weighting a dataset containing data representative of results of a study measuring activity of a plurality of participants. The process comprises obtaining a dataset containing data representative of results of a study measuring activity of a plurality of participants; designating a behavior; producing, for each of the participants, a single weighting factor based upon a total period of time of the study measuring the activity corresponding to the designated behavior; and weighting the data representative of the measured activity of each of the participants in accordance with the respective single weighting factor.

In accordance with yet an additional aspect of the present invention, a system for estimating which persons in a household engaged in predetermined media usage activities, media exposure activities and/or market activities attributed to the household, is provided. The system comprises at least one input for receiving household data representing a plurality of media usage activities, media exposure activities and/or market activities attributed to a household; the at least one input receiving individual member data representing an attribute of each of a plurality of household members; and a processor coupled to the at least one input to receive the household data and the individual member data and operative to separately assign each of the plurality of media usage activities, media exposure activities and/or market activities to a respective one of the household members based on the individual member data.

In accordance with still yet a further aspect of the present invention, a system is provided for converting data within a dataset representative of activity of a household having a plurality of members resulting from media and/or market research studies to data representative of activity of household members. The system comprises at least one input for receiving a first dataset identifying activity of the household carried out during a predetermined period of time during a first study, the first dataset including data representing a total amount of the activity carried out by the household during the predetermined period of time; the at least one input receiving a second dataset comprising results of a survey of participants in the household, the second dataset containing data indicating an amount of the activity carried out by each participant during the predetermined period of time; and a processor coupled to the at least one input and operative to: produce, for each of the household members who participated in the survey, data representing a determined amount of the activity carried out by the respective member carried out during the predetermined period of time based upon the total amount of usage represented by data in the first dataset and the indicated amounts in the second dataset; and produce data identifying each household member who participated in the survey and data representing the determined amount of the activity carried out by each respective household member.

In accordance with still yet another aspect of the present invention, a system is provided for preparing a media and/or market research report from data included in a dataset of media and/or market research data, the dataset including data records each pertaining to a corresponding participant in a media and/or market research activity and including participant related data representing at least one of the corresponding participant's attributes. The system comprises at least one input for receiving characteristics data defining a set of the participants to include in a media and/or market research report; the at least one input receiving behavior data defining a set of media usage activities, media exposure activities and/or market activities to include in the media and/or market research report; and a processor coupled to the input and operative to access data records from the dataset based on at least one of the characteristics data and the behavior data; and produce a media and/or market research report using data included in the accessed data records based on the characteristics data and the behavior data.

In accordance with still yet an additional aspect of the present invention, a system is provided for producing a report from datasets containing data representative of results of media usage, media exposure and/or market research studies, comprising: at least one input for receiving a first dataset including data representative of at least a first activity of participants in a first study; the at least one input receiving a second dataset including data representative of at least a second activity of participants in a second study; the at least one input receiving an identified characteristic for use in generating a report, the characteristic being one of the first activity and the second activity; the at least one input receiving an identified behavior for use in generating the report, the behavior being the other of the first activity and the second activity; and a processor coupled to the at least one input and operative to: select participants for inclusion in the report based upon participants who carried out the identified characteristic; and include data in the report representing the identified behavior of the selected participants.

In accordance with yet a further aspect of the present invention, a system is provided for producing a report from datasets containing data representative of results of studies measuring different activity. The system comprises at least one input for receiving data from a plurality of datasets each including data representative of activity of participants in a respective study; the at least one input receiving an identified characteristic for use in generating a report; and a processor coupled to the at least one input and operative to: select a first dataset from the plurality of datasets measuring activity of participants in the respective study corresponding to the identified characteristic for use in generating the report; select for inclusion in the report participants in the selected first dataset who, as indicated by the data of the first selected dataset, carried out the identified characteristic; identify a behavior to integrate with the identified characteristic; select a second dataset from the plurality of datasets measuring activity of participants in the respective study corresponding to the identified behavior, the participants in the study corresponding to the selected first dataset also being participants in the study corresponding to the selected second dataset; and produce a report including data representative of the participants selected for inclusion in the report and data representative of the activity of the participants selected for inclusion measured in the study corresponding to the selected second dataset.

In accordance with yet another aspect of the present invention, a system is provided for weighting a dataset containing data representative of results of a study measuring activity of a plurality of participants. The system comprises at least one input for receiving a dataset containing data representative of results of a study measuring activity of a plurality of participants, the at least one input receiving a designated behavior, and a processor coupled to the at least one input and operative to produce, for each of the participants, a single weighting factor based upon a total period of time of the study measuring the activity corresponding to the designated behavior, and weight the data representative of the measured activity of each of the participants in accordance with the respective ascertained single weighting factor.

### BRIEF DESCRIPTION OF THE DRAWINGS

FIG. 1 is a block diagram illustrating a system for converting household level data to person level data.

FIG. 2 is a block diagram illustrating another system for converting household level data to person level data.

FIG. 3 is a block diagram illustrating yet another system for converting household level data to person level data.

FIG. 4 is a block diagram illustrating a system for integrating datasets.

FIG. 5 is a block diagram illustrating another system for integrating datasets.

### DETAILED DESCRIPTION OF CERTAIN ADVANTAGEOUS EMBODIMENTS

Certain embodiments comprise systems and processes to convert household-level data representing media exposure, media usage and/or consumer behavior to person-level data. Certain embodiments comprise systems and processes to combine data from multiple sources, perhaps provided in different formats, timeframes, etc., to produce various data describing the conduct of a study participant or panelist as a single source of data reflecting multiple purchase and/or media usage activities. This enables an assessment of the links between exposure to advertising and the shopping habits of consumers. In certain embodiments, data about panelists is gathered relating to one or more of the following: panelist demographics; exposure to various media including television, radio, outdoor advertising, newspapers and magazines; retail store visits; purchases; internet usage; and consumers beliefs and opinions relating to consumer products and services. This list is merely exemplary and other data relating to consumers may also be gathered.

Various datasets may be produced by different organizations, in different manners, at different levels of granularity, regarding different data, pertaining to different timeframes, and so on. Certain embodiments integrate data from different datasets. Certain embodiments convert, transform or otherwise manipulate the data of one or more datasets. In certain embodiments, datasets providing data relating to the behavior of households are converted to data relating to behavior of persons within those households. In certain embodiments, data from datasets are utilized as “targets” and other data utilized as “behavior.” In certain embodiments, datasets are structured as one or more relational databases. In certain embodiments, data representative of respondent behavior is weighted.

For each of the various embodiments described herein, datasets are provided from one or more sources. Examples of datasets that may be utilized include the following: datasets produced by Arbitron Inc. (hereinafter “Arbitron”) pertaining to broadcast, cable or radio (or any combination thereof); data produced by Arbitron's Portable People Meter System; Arbitron datasets on store and retail activity; the Scarborough retail survey; the JD Power retail survey; issue specific print surveys; average audience print surveys; various competitive datasets produced by TNS-CMR or Monitor Plus (e.g., National and cable TV; Syndication and Spot TV); Print (e.g., magazines, Sunday supplements); Newspaper (weekday, Sunday, FSI); Commercial Execution; TV national; TV local; Print; AirCheck radio dataset; datasets relating to product placement; TAB outdoor advertising datasets; demographic datasets (e.g., from Arbitron; Experian; Axiom, Claritas, Spectra); Internet datasets (e.g., Comscore; NetRatings); car purchase datasets (e.g., JD Power); purchase datasets (e.g., IRI; UPC dictionaries)

Datasets, such as those mentioned above and others, provide data pertaining to individual behavior or provide data pertaining to household behavior. Currently, various types of measurements are collected only at the household level, and other types of measurements are collected at the person level. For example, measurements made by certain electronic devices (e.g., barcode scanners) often only reflect household behavior. Advertising and media exposure, on the other hand, usually are measured at the person level, although sometimes advertising and media exposure are also measured at the household level. When there is a need to cross-analyze a dataset containing person level data and a dataset containing household level data, the existing common practice is to convert the dataset containing person level data into data reflective of the household usage, that is, person data is converted to household data. The datasets are then cross-analyzed. The resultant information strictly reflects household activity.

In accordance with certain embodiments, household data is converted to person data in manners that are unique and provide improved accuracy. The converted data may then be cross-analyzed with other datasets containing person data. In certain embodiments described below, household to person conversion (also called translation herein) is based on characteristics and/or behavior. In certain embodiments, household to person conversion is modeled or based on statements in response to survey questions. In certain embodiments, person data derived from a household database may then be combined or cross-analyzed with other databases reflecting person data.

Currently, databases that provide data pertaining to Internet related activity, such as data that identifies websites visited and other potentially useful information, generally include data at the household level. That is, it is common for a database reflecting Internet activity not to include behavior of individual participants (i.e., persons). While some Internet measurement services measure person activity, such services introduce additional burdens to the respondent. These burdens are generally not desirable, particularly in multi-measurement panels. Similarly, databases reflective of shopping activity, such as consumer purchases, generally include only household data. These databases thus do not include data reflecting individuals' purchasing habits. Examples of such databases are those provided by IRI, HomeScan, NetRatings and Comscore.

As described herein, certain embodiments of the present invention convert household purchasing activity to household member-specific purchasing activity. Advantageously, by knowing who purchased each item the impact of advertising on that purchaser can be assessed. In particular, the effect of advertising exposure on the purchaser can be assessed if purchase data can be attributed at the person level. The effect on purchase behavior can also be assessed if the person exposed to the commercial is not the purchaser, but rather another member of the purchaser's household. In either case, certain embodiments of the present invention advantageously enable organizations to establish the nexus between exposure to advertisements and the purchase of products and/or services advertised.

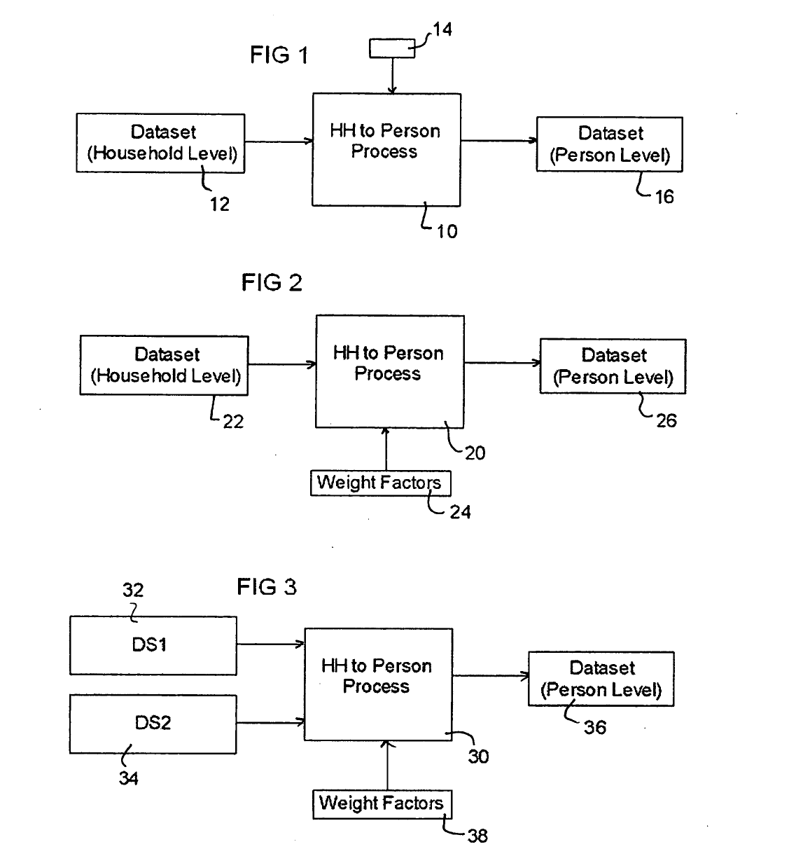

In accordance with certain embodiments of the present invention, conversion of household data to person data is based on attributes of the household members. Referring to FIG. 1, household (HH) to person process 10, generally carried out by a computing device such as a computer or computer system, obtains a dataset 12 containing data at the household level. Based upon certain household member attributes 14, process 10 employing certain techniques ascertains the head-of-household purchaser of the product under consideration. The resultant selection is then utilized to generate data reflective of this information for inclusion in a dataset 16.

In one particular embodiment, the female head-of-household is assigned to be the principal shopper for items for which women would shop and the male head-of-household is assigned to be the principal shopper for items for which men would shop. In certain embodiments, head-of-household status is applied based upon an assessment of the make-up of the household.

In certain embodiments, and with reference to FIG. 2, data from household dataset 22 is translated into person data for inclusion in dataset 26 by weighting, within process 20, each person in the household based on the probability that the individual carried out the activity. Weighting is based upon various weight factors 24. Then, the member with the highest weight for an identified behavior, such as a product purchase, is deemed to be the person who carried out the behavior. In various embodiments, the type of behavior will impact the value of the weights applied to the members. In certain embodiments, the weights are derived (or re-weighted) so that their sum equals one.

In certain embodiments, children household members are included. In the various embodiments that weight household members, children likewise are assigned weights.

For example, when a household includes individuals under 18 years of age (i.e., children), a maximum designated weight for children is assigned, and lower values decrementally are assigned to younger individuals. In one variation, a maximum value is established for a 17 year old individual, and children of other ages are assigned a value equal to the maximum value multiplied by the respective child's age divided by 17. For example: if the maximum weight is 0.51 (e.g., for a 17 year old), then a 10 year old child is assigned a weight of 0.3. That is, (0.51*10)/17=0.3. In other variations, this weighting scheme may be applied to children (or even young adults) of other ages. For example, an adult can be deemed to be a person 21 years old or older, with younger individuals being assigned weights using this formula or a similar formula. As another example, it may be appropriate to use a similar formula for children 16 (or even 15) years of age and younger. In yet another variation, the age of a “child” (i.e., when the formula is applied) is dependent upon the type of product purchased.

In accordance with certain embodiments, household member weights are derived based upon employment status. Various employment statuses include: full-time; part-time and unemployed. Other statuses include: night-time employed and day-time employed. Other employment status/factors may also be utilized, such as type of employer (e.g., government, corporate, private, partnership, sole-proprietor, etc.), type of occupation or profession, distance (time and/or miles) to travel to work, location of employment (city, suburbs, country, in home, etc.), and so on. In one example, an unemployed household member (e.g., a “stay-at-home” spouse) is assigned a weight of 1.0; a part-time employed member is assigned a weight of 0.7; and a full-time employed member is assigned a weight of 0.3. Preferably, weighting based upon employment status is applied only to individuals 18 years of age or older.

In certain embodiments, weights are applied to household members based upon gender. For example, a greater weight is assigned to women than to men in circumstances where it is more likely a product or service would be purchased by a woman. The value of the weights assigned may vary depending on the behavior carried out. For example, these weight values are assigned when the behavior is the purchase of a product typically purchased by women. For a product typically purchased by men, these weight values may be reversed.

In certain embodiments, multiple weights are assigned to each household member and then all of the weights assigned to an individual are multiplied together to produce a collective weight for that individual. The household member with the highest collective weight is deemed the person who carried out the behavior. For example, a dataset includes data that indicates that a household had purchased a product that is normally purchased by women, and the household has three members: a man, a woman and a 7 year old child. The woman is employed full time. The man is employed part-time. Conversion of the data from household data to person data is carried out by employing two sets of weights: (1) gender; and (2) employment status. The woman is assigned a gender weight of 1.0 and an employment status weight of 0.3 (full-time employed). The resultant collective weight for the woman is 0.3. The man is assigned a gender weight of 0.5 and an employment status weight of 0.7 (part-time employed). The resultant collective weight for the man is 0.35. Children weights also are utilized, with a preset maximum weight of 0.51 (or other suitable weight) applied to children age 17. The 7 year old child is assigned a child weight of 0.21 ((7*0.51)/17=0.21), and a second weight as a child (e.g., for employment status) of, for example, 0.5. The child's collective weight thus is 0.105. The man has the largest collective weight for the behavior under consideration and, thus, the man is deemed to have carried out the behavior. Data reflective of this result is generated and included within dataset 26.

The above example illustrates the usage of two sets of weights: gender and employment status. Other sets of weights may be utilized, such as any of those mentioned herein and others not mentioned. In addition, three, four or more sets of weights may be utilized concurrently.

In certain embodiments of the present invention, multiple sets of weights are utilized and assigned to each household member, and those weights are summed together to produce the member's collective weight. Preferably, after all of the collective weights are computed, the collective weights are re-weighted so that their sum equals one. The household member with the highest collective weight is deemed to be the person who carried out the behavior under consideration.

In accordance with certain embodiments of the present invention, household data containing data representative of household computer usage is converted to person data. Computer usage generally is tracked at the computer level, independent of who used that particular computer and, thus, electronic measures of computer usage (and other means for measuring usage) generate data at the household level. If Internet usage is being tracked, the resultant Internet usage data likewise represents household data.

A dataset containing data representative of household computer usage, in particular Internet usage, may be converted to person data in accordance with certain embodiments described herein. In such embodiments, weights may be applied to household members based upon employment status, gender, age, and/or other factors, including but not limited to those mentioned above. In addition, the gender or other attributes of persons may be taken into account in assessing the likelihood they visted specified websites.

In accordance with certain embodiments, household data is converted into person data by employing a second dataset containing survey data. Referring to FIG. 3, a first dataset 32 (DS1) contains data representative of the household's computer usage and a second dataset 34 (DS2) contains survey data. The survey data reflects respondents' answers to survey questions about their computer and/or Internet usage, as well as e-mail usage. Since survey data reflects each individual's behavior or activity, such survey data represents data at the person level. Examples of survey data and datasets, as well as manners of taking surveys, are well known and thus are not discussed in detail herein.

As mentioned above, the first dataset 32 contains data pertaining to a household's computer usage and/or Internet usage and the second dataset 34 contains survey data. The survey data reflects each household member's perceived or believed amount of usage during a period of time. The survey usually includes other information. For example, dataset 34 contains regular diary measurement data and includes the fields: person ID; household ID; prior usage (e.g., amount of time on computer during a certain calendar period); and date of the survey. As for the other dataset, dataset 32 contains continuous electronic computer measurement data, and includes the fields: computer household ID (identification); date; time and usage.

In accordance with one embodiment, process 30 ascertains each household member's actual usage based upon each household member's indicated usage (in the survey data), the household's total indicated usage (also in the survey data) and actual total amount of Internet usage (in the computer measurement data). The usage of each person is particularly ascertained to be equal to the amount of usage of the respective household member identified on the survey normalized to the actual amount of total usage time identified by the first dataset 32. If the first dataset represents electronic measurement data, the first dataset represents accurate, unbiased data, whereas the survey data usually is not completely accurate due to human error. More particularly, each household member's usage is equal to the respective member's survey reported usage multiplied by the total electronic data identified usage divided by the sum of all member's survey reported usage.

In certain embodiments, integration is carried out in accordance with the following. (1) If the electronic computer measurement system was installed (and operating properly) and the dataset produced from measurements of that system identified that the household had no computer usage, then each person in the household is deemed to have had no usage regardless of the results of the survey. (2) If the electronic computer measurement system was not installed (i.e., not functioning or not set up), then the survey data alone is utilized to assess the amount of usage of each person in the survey. (3) If the electronic computer measurement system was installed and operating properly, and the dataset produced from measurements of that system identified that the household had computer usage, then each member's usage is ascertained as described above. (4) As a variation of (2) above, if the electronic computer measurement system was not installed (i.e., not functioning or not set up), then the survey data is utilized and adjusted based on average usage patterns when the computer system was set up or working properly.

In certain embodiments, data identifying household purchases over a period of time is converted to person level data by utilizing survey data. A first dataset reporting continuous electronic measurement of product purchasing (e.g., by barcode scanning) of households includes the following fields: household identification (HH ID); date; time and purchased items. A second dataset reporting periodic diary measurement includes the following fields: person ID; household ID, times shopped; type of items purchased; and date of survey. For the diary measurement, members of households individually report their purchasing activities, but usually in a somewhat general manner. For example, the type of items purchased may be a list of types of products, with or without indications of brand names, sizes, prices, model numbers, etc. As used herein, a “diary” or “diary measurement” includes a panelist maintaining a manual record (written or oral), but also includes a panelist answering questions posed during one or more interviews, whether taken over the telephone, on-line or in-person, or by any other method.

In certain embodiments, the type of an item under consideration purchased by a household as identified by the electronic measurement (i.e., the first dataset) is matched to each member of that household who identified in the survey (i.e., the second dataset) that he/she purchased such type of item. Each person's ascertained probability of having purchased the item under consideration is based on the relative share of reported shopping by that member. The member in the household with the highest probability is deemed the purchaser of the item under consideration.

In a particular refinement of this embodiment, ascertained probabilities of household members not deemed to be the purchaser of an item under consideration are “carried forward” and accumulated with subsequent probabilities ascertained for each household member for another purchased item falling within the same type. For example, if household members m1, m2, m3 and m4 are assessed to have probabilities of likelihood of purchasing a product p1 of 30%, 40%, 25% and 5%, respectively, then member m2 is deemed to have purchased product p1. If purchased product p2 is of a different type (e.g., p1 is ice cream and p2 is shaving cream), then the previously ascertained probabilities of the members of having purchased p1 (ice cream) have no impact on the assessment of who purchased p2 (shaving cream). However, if product p3 is of the same type as p1 (e.g., p3 is frozen yogurt), then the previously assessed probabilities of members m1, m3 and m4 are added to their assessed probabilities of having purchased p3. As noted above, the second dataset comprises diary data and includes, for each member, types of items purchased and times shopped. If multiple members report that they have purchased a particular type of product (e.g., frozen dessert) within a certain time frame, the “carrying forward” of probabilities for members not deemed to have purchased a given product appropriately distributes purchased products amongst those household members who have indicated in the survey that they have purchased certain types of products. Thus, a household member who has, for example, a 10% probability of purchasing a certain type of product will likely not be deemed the purchaser several times for products of such type, but will eventually be deemed the purchaser of a product of such type after his/her probability has increased sufficiently.

In a variation of the embodiment discussed above, a product purchase is assigned based on the household members' assigned probabilities and a random number. Each household member is assigned a respective “proportion range” based upon the probability that the member purchased a particular item, and a randomly selected number designates the purchasing member in the following manner. Using the respective probabilities of the household members mentioned above (i.e., 30%, 40%, 25% and 5%) with respect to product p1, household member m1 is assigned the range 0-29 (representing a 30% probability), member m2 is assigned the range 30-69(representing a 40% probability), member m3 is assigned the range 70-94(representing a 25% probability), and member m4 is assigned the range 95-99(representing a 5% probability). A random number between (and inclusive of) 0 and 99 is selected and designates the member who is deemed to have purchased product p1. For example, a random number of 27 deems member m1 the purchaser. Equivalent probability selection methods may be utilized.

In certain embodiments described herein, electronic product purchase data combined with survey data effectively enables the conversion of a product purchase household level dataset into a product purchase person level dataset. Preferably, the surveys are taken on a periodic basis.

In another embodiment of the present invention, a dataset identifying household Internet usage is converted to person level data using survey data and also utilizing so-called primary user and weighted user measurements. The primary Internet user is deemed to be the member of the household with the highest number of hours of usage of the Internet as stated in the survey dataset. If, however, that person did not respond to the survey, then a single member of the household may be selected as the primary user based on age using the youngest person over age 18. The Internet users are weighted by using the mid-level of hours in the range specified in the survey as the weight; adjusting each person's weight (within the household) so that the sum of the weights is 1.0; and if none of the persons in the household responded to the survey, then each person is given an equal weight.

In certain embodiments relating to purchasing behavior, a principle shopper is designated utilizing the following rules. (1) In a single person household, that person in deemed the principal shopper. (2) An adult aged 18 years or older preferably is selected as the principal shopper. (3) Multiple adults within a household are ranked by employment status, with non-employed being ranked highest, followed by part-time employed, and then full-time employed. In the case of a tie, the female is selected. If there is a tie between two female adults, the person with the lower identification (e.g., higher priority) is deemed the principle shopper, where, in general, the head of household retains a lower identification, with adult children as well as grandparents having higher identifications.

In certain embodiments, weights are utilized to assess members' likelihood of purchase of a particular product and the following criteria are followed in assigning those weights: (1) In a single person household, that person is provided a weight of 1.0 (i.e., selected as the purchaser). (2) For children under age 18, weights are assigned as a function of age, with younger children receiving smaller weights than older children. The function preferably is linear so that a child's weight is equal to his/her age multiplied by a preset number. (3) For adults, unemployed persons are given the highest weight, followed by part time persons, and full time employed individuals are provided the lowest weight amongst the adults. These weights also may take into account the type of product purchased. (4) Each adult man's weight is factored by 0.33. (5) All weights in each household are adjusted to sum to 1.0.

The various embodiments discussed above relate to the conversion of one or more datasets containing household level data to one or more datasets containing person level data and/or the integration of household level data with person level data. Certain ones of these embodiments can be utilized to convert data representative of a single instance of household behavior to person level data.

Whether or not one or more datasets are (or need to be) converted to datasets containing person level data, certain embodiments of the present invention entail the creation of a single reporting structure to enable the integration of multiple datasets. These embodiments and others described herein provide a structure to allow a user to meaningfully use all of the information provided within the datasets, without getting lost in the endless possibilities that may exist when data from different datasets are integrated. Various embodiments discussed herein frame the questions utilized to build a report while, at the same time, remain open to the particular level of detail and the type of reports generated. Certain embodiments further assist in determining the weights for each person within the datasets.

In accordance with certain embodiments of the present invention, a report includes two elements: (1) a set of characteristics; and (2) a set of behaviors.

A characteristic (also called a “framework characteristic”), as this term is used within the various embodiments described relating to reporting frameworks, determines the persons who are included in the report. Multiple characteristics may be utilized. The data may come from any period of time from any survey or panel measurement. For example, a characteristic may be people who bought bread in the last two years. Another characteristic may be people who have a good credit rating. A further characteristic may be people who are heavy users of cable television. Yet another characteristic may be people who listen to a particular radio program. Yet a further characteristic may be people who shopped at a particular retail store. There are numerous characteristics that may be utilized and thus the foregoing characteristics are for illustrative purposes only.

A behavior (also called a “framework behavior”), as this term is used within the various embodiments described relating to reporting frameworks, identifies something (activity, exposure, beliefs, etc.) that is reported for those persons who are included in the report as determined by the framework characteristic. For example, one behavior might be “viewed a commercial for bread.” Another behavior may be “purchased bread in a specific month.” A further behavior may be “watched a designated amount of a specified television broadcast or channel.” There are numerous other behaviors that may be utilized and thus the foregoing behaviors are for illustrative purposes only.

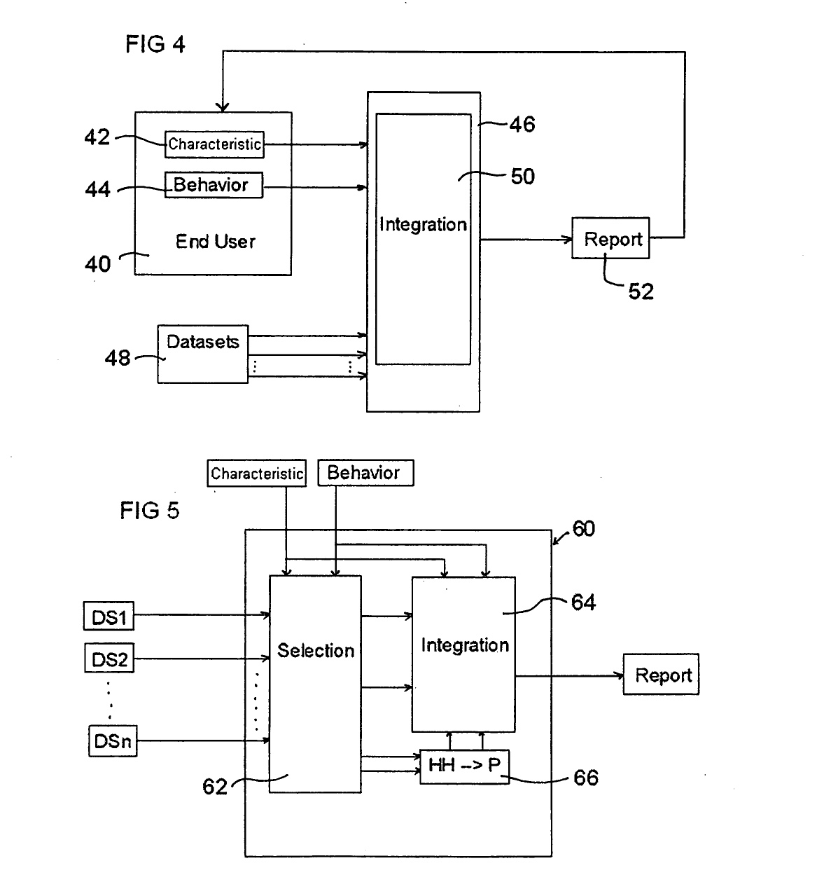

In certain embodiments, and referring to FIG. 4, an end user 40 identifies a characteristic 42 and a behavior 44 for utilization by a system 46 which carries out integration in accordance with certain embodiments described herein. System 46 may be disposed separate and apart from user 40. System 46 has access to multiple datasets 48, which may be stored within system 46 or, as shown, separate and apart from system 46. One or more datasets 48 may be provided to system 46 on demand or may be immediately accessible. As mentioned above, the various datasets may be provided by one or more sources.

System 46 integrates, utilizing an integration process 50, certain ones of the datasets based upon the designated characteristic and behavior and produces data for a report 52. The generated report 52 may be supplied to user 40 for further consideration and analysis. As described herein, the datasets integrated during the integration process may be specifically provided for integration or may be selected based upon various criteria.

Certain embodiments include, employ or contain one or more of the following advantageous features: the selection of datasets relating to different time periods; the selection of these time periods at the time of processing, also known as “on-the-fly;” the selection of time periods that start or end on any designated day; the selection of time periods without restriction to fixed periods of time; the selection of one or more characteristics and/or one or more behaviors on-the-fly; the creation of relational databases; the selection of surveys on-the-fly for use as criteria for compliance and inclusion in a report; the selection of panel results for analysis without restriction; the selection of multiple panel results for combination; the selection of measures of panel results for use and inclusion in reports without unnecessary restrictions.

In certain embodiments, panelist data is weighted to accurately reflect the population and usage, by adjusting the panelist data to correct for disparities between the demographic composition of the panel and that of the population under study. In certain embodiments, activities of the same respondents (panel members) participating in multiple surveys/panels during the same or different period of time, by different means to record or measure the activities, and with different levels of compliance, are integrated into a single reporting framework.

As discussed herein, different means to record or measure activities or exposure to media includes various types of instrumentation utilized for the measurement. For example, Arbitron's Portable People Meter is one type of electronic instrumentation. Many other types of electronic instrumentation are available. Non-electronic means for recording or measuring activity or exposure to media also are available, such as a survey.

Different measuring means will likely have different compliance requirements. For example, in the case of Arbitron's Portable People Meter, one compliance requirement is that the panel member carry around the meter at some point in a given day. In the case of, for example, tracking print readership, a compliance requirement is for the panelist to record their print reading activity on a given day. The panelist may comply with one requirement and not the other. Thus, even for the same period of time, it is possible for a panelist participating in two different studies (or a single study utilizing multiple data gathering techniques) to have different levels of compliance. For example, in a given month (e.g., April), the panelist may be compliant in one panel study for 24 days of that month and be compliant in another panel study for 11 days of that same month. The lengths of the panel studies in which the panelist is participating may be different. For example, one panel study in the example may have a period spanning six months from January through June, whereas the other panel study has a two-month period, April and May. Of course, these are only exemplary periods and levels of compliance and, thus, are for illustrative purposes only.

In certain embodiments, the concept of “intab” is employed. As is well known, intab refers to data deemed acceptable for use in reports because the panelist has adhered sufficiently to the prescribed compliance requirements.

In one example, a panelist participates in a first study relating to ascertaining exposure to advertisements and also participates in a second study relating to purchasing behavior. Certain embodiments integrate datasets containing data regarding these two studies, employ the above-mentioned characteristic and behavior framework and also employ weighting. In the example where a panelist participated in two different studies, it may be desired to assess the nexus between advertisement of a product and the purchasing of that product or similar products. To integrate the two datasets, the framework characteristic for the report to be generated is designated to be those persons who have purchased the product in question or those types of products in general, or other variation of this characteristic. The framework behavior is designated to be exposure to the specified advertisements, such data being available in the second dataset.

In certain embodiments, the user specifically identifies the datasets to be integrated. In certain other embodiments, the user does not identify the datasets to be integrated, but rather allows a selection process to select the datasets based upon the designated framework characteristic and framework behavior. Referring to FIG. 5, a system 60 includes a selection process module 62 for carrying out the above-mentioned selection of datasets for integration. A multitude of datasets DS1, DS2 . . . DSn are available for selection. Each of these datasets may be supplied by different sources and the datasets themselves may be maintained within one or more systems separate and apart from system 60. The selection process selects one or more datasets suitable for use for the designated framework behavior and, similarly, selects one or more datasets suitable for use for the designated framework characteristic. Also, as mentioned above, selection of the datasets may be done by the user at the time of processing.

After selection of the datasets to be integrated, an integration process module 64 integrates the selected datasets in accordance with certain embodiments of the present invention. In the event one or more selected datasets contain household level data, it may be desired or necessary to convert such datasets to reflect person level data utilizing a household to person conversion module (HH-->P) 66. Household to person conversion may be carried out in accordance with any appropriate previously described embodiment. A report is produced upon integration of the datasets. It is appreciated that the various modules mentioned may be carried out in separate devices or systems, or within the same device or system. In one example, system 60 is implemented by a processor that carries out the functions of all of the process modules thereof. In another example, the various processes are carried out by different processors that may be separate and apart from one another.

In certain embodiments, the compliance level of each participant of the framework behavior is not taken into account. Participants that are identified as having carried out or possess the designated framework characteristic are included in the report irrespective of each participant's compliance level in the study that measured the framework behavior. Each participant's compliance level and other factors in the framework behavior are, however, taken into account to ascertain the weights. In certain embodiments, intab status is taken into account.

Weighting is ascertained as a function of the participants' measured activity and characteristics with respect to the framework behavior. In particular, the period of time considered for weighting is based upon the period of the panel study pertinent to the framework behavior, rather than the period of the panel study pertinent to the framework characteristic. Hence, certain embodiments advantageously take into account only one period of time (i.e., the period of the study pertaining to the behavior) in ascertaining the weights to be utilized. Thus, integration of datasets that pertain to different time periods is carried out in a relatively simple manner.

In a more detailed example, provided for purposes of illustrating integration using the characteristic and behavior framework described herein, panelists participate in a first study that measures panelists' exposure to advertisements of a particular brand of dog food on both television and the Internet during the month of September (of the current year). The panelists also participate in a second study in the form of a survey that requests whether the survey participants purchased dog food of any brand in the last two years. In the example, the framework characteristic is who bought dog food in the last two years and the framework behavior is exposure to the television and Internet campaign. The second dataset provides data that relates to the framework characteristic and the first dataset provides data that relates to the framework behavior.

The integration process selects for inclusion in the report those survey participants who indicated they had purchased any brand of dog food in the last two years. However, the survey data is not utilized for weighting considerations. Thus, the only period of time utilized to identify respondents who will be weighted is the period of the first study.

The framework behavior in the example includes both television and Internet advertising. In certain embodiments, weighting takes both of these measures into account. Levels of compliance and intab status for each of these measures are relevant for establishing the factors in deriving the weights of the panelists included in the report.

A single weight is calculated for each participant to compensate for the television measure compliance level and the Internet measure compliance level. The single weight also is provided for the entire period, as opposed to providing daily weights. Typically, existing systems employ multiple and/or daily weights for media panel data where the number of people reporting accurate data on any given day may vary. Since a rating is a measurement of the percentage of people doing something on a given day, it is important to determine the correct number of people to count. The value of a multiple/daily weight is in the accuracy of each number reported. However, these behaviors preferably are not compared across different times, and also preferably are not compared to behaviors that were measured in another way that might have a different weight for that same day. Certain embodiments of the present invention, on the other hand, provide only a single weight for the entire period under consideration.

In certain embodiments, panelists who are not intab during the behavior period are not included. Thus, in the example, respondents who purchased dog food in the last two years and also who are intab in September for the study relating to television and Internet exposure are included in the report. In a variation, intab for each measure is considered. That is, if a respondent was intab for the television measure, but not for the Internet measure, then the panelist is included in the report, but only the television measure and compliance levels are considered for the weight. The behavior pertaining to the Internet measure is not utilized to determine the weight.

The level of compliance for each person in the report is ascertained across the entire period for the behavior. In the example, the entire period of the framework behavior was the month of September. Thus, the number of days each person (to be included in the report) was compliant in September for the television and Internet advertising study is considered. More particularly, the number of days in September a panelist was in compliance with respect to the television advertisement measure is ascertained, and the number of days in September a panelist was in compliance with respect to the Internet measure is separately ascertained. Each person is then assigned a compliance factor that is the inverse of his/her compliance. For two measures, in certain embodiments if a person was compliant x percent of the time for the television measure and y percent of the time for the Internet measure, that person's compliance factor is equal to the total days in the period (September) multiplied by two (for two measures) divided by the sum of the two compliance percentages. That is, the factor=(total days in period*2)/(x+y). Preferably, the factor is limited to a predetermined maximum compliance factor to minimize inaccuracies that may be caused due to excessively low compliance. Alternatively, respondents with low compliance may be excluded from the sample entirely.

In certain embodiments, the panelists' derived compliance factors are modified to adjust the weight for each respondent to conform to the demographics, behavioral breakdowns or other population category for such respondents. In particular, a population multiplier is ascertained for each person by dividing the total population for a given group (cell) by the sum of the factors for the respondents in that group. Each person's compliance factor is then multiplied by the ascertained population multiplier. Prior to ascertaining population weights, cells within the computation that do not have members are combined with other cells. In certain embodiments cells are combined within sex, by age from younger to older.

The final ascertained factor of each panelist is the weight applied to the behavior of that person. Totals of other measures (either electronic or otherwise), where compliance levels and/or populations are not considered, are attributed without the compliance factors.

In certain embodiments, the various factors (weights) are not combined so that behaviors of a respondent are not all multiplied by the same weight. In certain embodiments, behaviors that are part of the compliance determination are weighted by the combined weight. In certain embodiments, characteristics that are not included are multiplied by the population weight, which is the cell population divided by the number of respondents in that cell.

In certain embodiments, the period of the framework characteristic is selectable and may be the same or different from the period of the one or more panels which measured the specified behavior. In certain embodiments, the period of the frame behavior is selectable and may be the same or different from the period of the one or more panels which measured activity/exposure pertaining to the specified behavior. In certain embodiments, the period of the characteristic and the period of the behavior are selected, and integration is carried out in the manners previously described utilizing the selected periods.

As can be appreciated from the discussion herein, various difficulties have been overcome by the herein described inventive framework. In particular, when a panelist is included within multiple panels and/or surveys, certain embodiments of the present invention overcome the problem of assessing how to decide who is intab and what weights the individual is to be given. Certain embodiments further overcome difficulties in assessing different databases reporting different measures. Certain embodiments overcome general difficulties in handling reports pertaining to different periods of time. Certain embodiments overcome difficulties in assessing and reporting multiple forms of activities measured by different methods.

Specific examples are provided herein. These examples are for illustrative purposes only. In particular, the dataset relating to the purchase of dog food and the dataset relating to exposure to advertising of dog food is useful in understanding specifically how certain embodiments of the present invention may be applied in the context of specific databases. Datasets reporting other measurement data may be utilized with the various embodiments described.

Although various embodiments of the present invention have been described with reference to a particular arrangement of parts, features and the like, these are not intended to exhaust all possible arrangements or features, and indeed many other embodiments, modifications and variations will be ascertainable to those of skill in the art.

What is claimed is:

1. A process of estimating which persons in a household engaged in predetermined media usage activities, media exposure activities and/or market activities attributed to the household, comprising:
providing household data representing a plurality of media usage activities, media exposure activities and/or market activities attributed to a household;
providing individual member data representing an attribute of each of a plurality of household members; and
separately assigning each of the plurality of media usage activities, media exposure activities and/or market activities to a respective one of the household members based on the individual member data.

2. The process of claim 1, comprising producing likelihood data representing likelihoods that respective ones of the household members engaged in a selected one of the plurality of media usage activities, media exposure activities and/or market activities, and using the likelihood data to produce activity assignment data assigning the selected one of the plurality of media usage activities, media exposure activities and/or market activities to a respective one of the household members.

3. The process of claim 2, comprising producing the likelihood data based on the individual member data.

4. The process of claim 2, wherein the selected one of the plurality of media usage activities, media exposure activities and/or market activities comprises a first purchase of a predetermined type of goods and/or services, and the plurality of media usage activities, media exposure activities and/or market activities comprise a second purchase of the predetermined type of goods and/or services; the process comprising producing further activity assignment data assigning the second purchase to one of the household members other than the respective one of the household members to which the first purchase was assigned based on the likelihood data for the first purchase.

5. The process of claim 1, wherein the individual member data comprises purchasing behavior data.

6. The process of claim 1, wherein the individual member data comprises media usage behavior data.

7. The process of claim 1, wherein the individual member data comprises demographic data.

8. The process of claim 1, wherein providing household data comprises gathering the household data by means of an electronic device.

9. The process of claim 8, wherein providing individual member data comprises surveying the household members.

10. The process of claim 1, wherein the household data represents Internet usage.

11. The process of claim 1, wherein separately assigning each of the plurality of media usage activities, media exposure activities and/or market activities to a respective one of the household members based on the individual member data comprises:
producing, for each of the household members, a corresponding probability that the respective member carried out the respective activity represented in the household data;
establishing, for each of the household members, a weight based upon the corresponding probability of the respective member; and
assigning one of the household members as having carried out the activity as a function of the established weights of the household members.

12. The process of claim 11, wherein establishing a weight comprises establishing, for each member younger than a predetermined age, the weight of the respective member as a function of an age of the member.

13. The process of claim 11, wherein establishing a weight comprises establishing a maximum predetermined weight for each member having an age lower than a predetermined age, and establishing, for each of the other household members younger than the predetermined age, a weight that is both a function of the maximum predetermined weight and a function of an age of the respective member.

14. The process of claim 11, wherein establishing a weight comprises establishing, for each household member, the weight of the member based upon an employment status of the respective member.

15. The process of claim 11, wherein establishing a weight comprises establishing, for each household member, the weight of the member based upon a gender of the respective member and a gender of persons who typically carry out the activity represented in the household data.

16. The process of claim 11, wherein the household data represents a plurality of products purchased by the household; comprising producing, for each household member, a probability that the respective member had purchased one of the products represented by the household data; and assigning one of the household members as having purchased said one of the products as a function of the established weights of the household members.

17. The process of claim 1, comprising:
establishing, for each of the household members, a first weight as a function of a first characteristic of the respective household member;
establishing, for each of the household members, a second weight as a function of a second characteristic of the respective household member;
producing, for each of the household members, a collective weight as a function of the established first and second weights of the respective household member; and
assigning one of the household members as having carried out the activity based upon the produced collective weights of the household members.

18. The process of claim 17, comprising producing, for each of the household members, the collective weight by multiplying the established first and second weights of the respective member.

19. The process of claim 1, wherein the provided household data comprises a first dataset identifying products purchased by the household during a predetermined period of time obtained during a first study; the provided individual member data comprises a second dataset comprising results of a survey of members in the household participating in the survey, the second dataset containing data for each of the participating members identifying at least types of products purchased by the respective member during the predetermined period of time.

20. The process of claim 19, wherein separately assigning each of the plurality of media usage activities, media exposure activities and/or market activities to a respective one of the household members based on the individual member data comprises:
producing data, for each product purchased by the household as identified in the first dataset, identifying a household member who likely purchased the respective product based upon the data in the second dataset.

21. The process of claim 20, wherein the second dataset further includes, for each member participating in the survey, shopping data identifying a number of times the respective member shopped during the predetermined period of time; and, for each product purchased by the household as identified in the first dataset, producing data identifying the household member who likely purchased the respective product based upon the shopping data of the respective member.

22. The process of claim 20, comprising assigning, for each product purchased by the household as identified in the first dataset, a probability that each respective member purchased the respective product based upon the data in the second dataset.

23. The process of claim 22, comprising carrying forward probabilities of members not assigned as a purchaser of a product of a certain type and combining the probabilities carried forward with probabilities of members having purchased another product of the certain type.

24. A process of converting data within a dataset representative of activity of a household having a plurality of members resulting from media and/or market research studies to data representative of activity of household members, comprising:
obtaining a first dataset identifying an activity of the household carried out during a predetermined period of time during a first study, the first dataset including data representing a total amount of the activity carried out by the household during the predetermined period of time;
obtaining a second dataset comprising results of a survey of participants in the household, the second dataset containing data indicating an amount of the activity carried out by each participant during the predetermined period of time;
for each of the household members who participated in the survey, producing data representing a determined amount of the activity carried out by the respective member during the predetermined period of time based upon the total amount of usage represented by data in the first dataset and the indicated amounts in the second dataset; and
producing data identifying each household member who participated in the survey and data representing the determined amount of the activity carried out by each respective household member.

25. The process of claim 24, wherein the first study comprises automatically recording a total amount of usage of the Internet by the household, and the second study comprises a survey asking each of the household members how much Internet usage the respective member carried out during the predetermined period of time; and comprising producing data representing an amount of Internet usage by each member participating in the survey.

26. The process of claim 25, comprising, for each of the household members who participated in the survey, producing data representing an amount of Internet usage thereby based on data representing an amount of Internet usage thereof from the second dataset multiplied by the total amount of usage identified in the first dataset divided by a sum of all of the household members reported usage in the second dataset.

27. A process of preparing a media and/or market research report from data included in a dataset of media and/or market research data, the dataset including data records each pertaining to a corresponding participant in a media and/or market research activity and including participant related data representing at least one of the corresponding participant's attributes, comprising:
providing characteristics data defining a set of the participants to include in a media and/or market research report;
providing behavior data defining a set of media usage activities, media exposure activities and/or market activities to include in the market research report;
accessing data records from the dataset based on at least one of the characteristics data and the behavior data; and
producing a media and/or market research report using data included in the accessed data records based on the characteristics data and the behavior data.

28. The process of claim 27, wherein the characteristics data includes a characteristics time period and the behavior data includes a behavior time period; and accessing data records comprises accessing data records in accordance with the characteristics and behavior time periods.

29. The process of claim 27, wherein accessing data records comprises selecting records pertaining to participants in the market research activity who correspond to the provided characteristics data, and accessing the selected records based upon the provided behavior data.

30. The process of claim 27, comprising selecting at least one of a plurality of datasets available for selection, the selected dataset including data records pertinent to at least one of the provided characteristics data and the provided behavior data.

31. A process of producing a report from datasets containing data from media usage, media exposure and/or market research studies, comprising:
obtaining a first dataset including data representative of at least a first activity of participants in a first study;
obtaining a second dataset including data representative of at least a second activity of participants in a second study;
identifying a characteristic for use in generating a report, the characteristic being one of the first activity and the second activity;
identifying a behavior for use in generating the report, the behavior being the other of the first activity and the second activity;
selecting participants for inclusion in the report based upon data from at least one of the first dataset and the second dataset indicating participants who carried out the identified characteristic; and
including data in the report representing the identified behavior of the selected participants.

32. The process of claim 31, wherein the data of the first dataset represents exposure to an advertisement advertising a product or service; the data of the second dataset represents a purchase of the product or service advertised by the advertisement; the process comprising correlating exposure to the advertisement with the purchase of the product or service.

33. The process of claim 31, wherein selecting participants comprises selecting participants irrespective of levels of compliance of participants in the study measuring the activity corresponding to the behavior.

34. The process of claim 31, wherein the first study spans a first period of time and the second study spans a second period of time different from the first period of time.

35. The process of claim 34, wherein selecting participants comprises selecting participants who carried out the identified characteristic within the period of time of the study measuring the activity corresponding to the characteristic.

36. The process of claim 34, comprising weighting data representative of the identified behavior of the selected participants based upon the period of time of the study measuring the activity corresponding to the behavior.

37. The process of claim 34, comprising applying, to the identified behavior of each of the selected participants, a respective single weight to compensate for different levels of compliance of the participants included in the report over the period of time of the study measuring the activity corresponding to the behavior.

38. A process of producing a report from datasets containing data representative of results of studies measuring different activity, comprising:
obtaining access to a plurality of datasets each including data representative of activity of participants in a respective study;
identifying a characteristic for use in generating a report;
selecting a first dataset from the plurality of datasets measuring activity of participants in the respective study corresponding to the identified characteristic for use in generating the report;
selecting for inclusion in the report participants in the selected first dataset who, as indicated by the data of the first selected dataset, carried out the identified characteristic;
identifying a behavior to integrate with the identified characteristic;
selecting a second dataset from the plurality of datasets measuring activity of participants in the respective study corresponding to the identified behavior, the participants in the study corresponding to the selected first dataset also being participants in the study corresponding to the selected second dataset; and
producing a report including data representative of the participants selected for inclusion in the report and data representative of the activity of the participants selected for inclusion measured in the study corresponding to the selected second dataset.

39. The process of claim 38, comprising weighting the data representative of the activity measured in the study corresponding to the selected second dataset based upon a period of time of the study corresponding to the second selected dataset.

40. The process of claim 38, wherein the selected second dataset includes data representative of measured activity of participants resulting from at least two measures pertaining to the activity; the process comprising applying, to the measured activity of each of the participants, a respective single weight to compensate for different levels of compliance of the participants corresponding to the at least two measures.

41. The process of claim 40, wherein the single weight applied to the measured activity of each of the participants is a function of an inverse of a combination of levels of compliance of the respective participant corresponding to the at least two measures.

42. A process of weighting a dataset containing data representative of results of a study measuring activity of a plurality of participants, comprising:
obtaining a dataset containing data representative of results of a study measuring activity of a plurality of participants;
designating a behavior;
producing, for each of the participants, a single weighting factor based upon a total period of time of the study measuring the activity corresponding to the designated behavior; and
weighting the data representative of the measured activity of each of the participants in accordance with the respective single weighting factor.

43. The process of claim 42, wherein the ascertaining step is carried out by ascertaining, for each of the participants, the single weighting factor to compensate for different levels of compliance of the participants over the total period of time of the study.

44. A system for estimating which persons in a household engaged in predetermined media usage activities, media exposure activities and/or market activities attributed to the household, comprising:
at least one input for receiving household data representing a plurality of media usage activities, media exposure activities and/or market activities attributed to a household;
the at least one input receiving individual member data representing an attribute of each of a plurality of household members; and
a processor coupled to the at least one input to receive the household data and the individual member data and operative to separately assign each of the plurality of media usage activities, media exposure activities and/or market activities to a respective one of the household members based on the individual member data.

45. The system of claim 44, wherein the processor is further operative to produce likelihood data representing likelihoods that respective ones of the household members engaged in a selected one of the plurality of media usage activities, media exposure activities and/or market activities, and to use the likelihood data to produce activity assignment data assigning the selected one of the plurality of media usage activities, media exposure activities and/or market activities to a respective one of the household members.

46. The system of claim 45, wherein the processor is further operative to produce the likelihood data based on the individual member data.

47. The system of claim 45, wherein the selected one of the plurality of media usage activities, media exposure activities and/or market activities comprises a first purchase of a predetermined type of goods and/or services, and the plurality of media usage activities, media exposure activities and/or market activities comprise a second purchase of the predetermined type of goods and/or services; the processor being operative to produce further activity assignment data assigning the second purchase to one of the household members other than the respective one of the household members to which the first purchase was assigned based on the likelihood data for the first purchase.

48. The system of claim 44, wherein the individual member data comprises purchasing behavior data.

49. The system of claim 44, wherein the individual member data comprises media usage behavior data.

50. The system of claim 44, wherein the individual member data comprises demographic data.

51. The system of claim 44, further comprising an electronic device gathering the household data.

52. The system of claim 51, further comprising means for surveying the household members.

53. The system of claim 44, wherein the household data represents Internet usage.

54. The system of claim 44, wherein the processor is operative to:
produce, for each of the household members, a corresponding probability that the respective member carried out the respective activity represented in the household data;
establish, for each of the household members, a weight based upon the corresponding probability of the respective member; and
assign one of the household members as having carried out the activity as a function of the established weights of the household members.

55. The system of claim 54, wherein the processor is operative to establish, for each member younger than a predetermined age, the weight of the respective member as a function of an age of the member.

56. The system of claim 54, wherein the processor is operative to establish a maximum predetermined weight for each member having an age lower than a predetermined age, and to establish, for each of the other household members younger than the predetermined age, a weight that is both a function of the maximum predetermined weight and a function of an age of the respective member.

57. The system of claim 54, wherein the processor is operative to establish, for each household member, the weight of the member based upon an employment status of the respective member.

58. The system of claim 54, wherein the processor is operative to establish, for each household member, the weight of the member based upon a gender of the respective member and a gender of persons who typically carry out the activity represented in the household data.

59. The system of claim 54, wherein the household data represents a plurality of products purchased by the household; and the processor is operative to produce, for each household member, a probability that the respective member had purchased one of the products represented by the household data, and to assign one of the household members as having purchased said one of the products as a function of the established weights of the household members.

60. The system of claim 44, wherein the processor is operative to:
establish, for each of the household members, a first weight as a function of a first characteristic of the respective household member;
establish, for each of the household members, a second weight as a function of a second characteristic of the respective household member;
produce, for each of the household members, a collective weight as a function of the established first and second weights of the respective household member; and
assign one of the household members as having carried out the activity based upon the produced collective weights of the household members.

61. The system of claim 60, wherein the processor is operative to produce, for each of the household members, the collective weight by multiplying the established first and second weights of the respective member.

62. The system of claim 44, wherein the household data comprises a first dataset identifying products purchased by the household during a predetermined period of time obtained during a first study; the individual member data comprises a second dataset comprising results of a survey of members in the household participating in the survey, the second dataset containing data for each of the participating members identifying at least types of products purchased by the respective member during the predetermined period of time.

63. The system of claim 62, wherein the processor is operative to produce data, for each product purchased by the household as identified in the first dataset, identifying a household member who likely purchased the respective product based upon the data in the second dataset.

64. The system of claim 63, wherein the second dataset further includes, for each member participating in the survey, shopping data identifying a number of times the respective member shopped during the predetermined period of time; and, for each product purchased by the household as identified in the first dataset, producing data identifying the household member who likely purchased the respective product based upon the shopping data of the respective member.

65. The system of claim 63, wherein the processor is operative to assign, for each product purchased by the household as identified in the first dataset, a probability that each respective member purchased the respective product based upon the data in the second dataset.

66. The system of claim 65, wherein the processor is operative to carry forward probabilities of members not assigned as a purchaser of a product of a certain type and to combine the probabilities carried forward with probabilities of members having purchased another product of the certain type.

67. A system for converting data within a dataset representative of activity of a household having a plurality of members resulting from media and/or market research studies to data representative of activity of household members, comprising:
at least one input for receiving a first dataset identifying activity of the household carried out during a predetermined period of time during a first study, the first dataset including data representing a total amount of the activity carried out by the household during the predetermined period of time;
the at least one input receiving a second dataset comprising results of a survey of participants in the household, the second dataset containing data indicating an amount of the activity carried out by each participant during the predetermined period of time; and
a processor coupled to the at least one input and operative to:
produce, for each of the household members who participated in the survey, data representing a determined amount of the activity carried out by the respective member carried out during the predetermined period of time based upon the total amount of usage represented by data in the first dataset and the indicated amounts in the second dataset; and
produce data identifying each household member who participated in the survey and data representing the determined amount of the activity carried out by each respective household member.

68. The system of claim 67, wherein the first study comprises automatically recording a total amount of usage of the Internet by the household, and the second study comprises a survey asking each of the household members how much Internet usage the respective member carried out during the predetermined period of time; and the processor is operative to produce data representing an amount of Internet usage of each member participating in the survey.

69. The system of claim 68, wherein the processor is operative to produce, for each of the household members who participated in the survey, data representing an amount of Internet usage thereby based on data representing an amount of Internet usage thereof from the second dataset multiplied by the total amount of usage identified in the first dataset divided by a sum of all of the household members reported usage in the second dataset.

70. A system for preparing a media and/or market research report from data included in a dataset of media and/or market research data, the dataset including data records each pertaining to a corresponding participant in a media and/or market research activity and including participant related data representing at least one of the corresponding participant's attributes, comprising:
at least one input receiving characteristics data defining a set of the participants to include in a media and/or market research report;
the at least one input receiving behavior data defining a set of media usage activities, media exposure activities and/or market activities to include in the media and/or market research report; and
a processor coupled to the at least one input and operative to:
access data records from the dataset based on at least one of the characteristics data and the behavior data; and
produce a media and/or market research report using data included in the accessed data records based on the characteristics data and the behavior data.

71. The system of claim 70, wherein the characteristics data includes a characteristics time period and the behavior data includes a behavior time period; and the processor is operative to access data records in accordance with the characteristic and behavior time periods.

72. The system of claim 70, wherein the processor is operative to select records pertaining to participants in the media and/or market research activity who correspond to the provided characteristics data, and to access the selected records based upon the provided behavior data.

73. The system of claim 70, wherein the processor is operative to select at least one of a plurality of datasets available for selection, the selected dataset including data records pertinent to at least one of the provided characteristics data and the provided behavior data.

74. A system for producing a report from datasets containing data representative of results of media usage, media exposure and/or market research studies, comprising:
at least one input for receiving a first dataset including data representative of at least a first activity of participants in a first study;
the at least one input receiving a second dataset including data representative of at least a second activity of participants in a second study;
the at least one input receiving an identified characteristic for use in generating a report, the characteristic being one of the first activity and the second activity;
the at least one input receiving an identified behavior for use in generating the report, the behavior being the other of the first activity and the second activity; and
a processor coupled to the at least one input and operative to:
select participants for inclusion in the report based upon participants who carried out the identified characteristic; and
include data in the report representing the identified behavior of the selected participants.

75. The system of claim 74, wherein the data of the first dataset represents exposure to an advertisement advertising a product or service; the data of the second dataset represents a purchase of the product or service advertised by the advertisement; and the processor is operative to correlate exposure to the advertisement with the purchase of the product or service.

76. The system of claim 74, wherein the processor is operative to select participants irrespective of levels of compliance of participants in the study measuring the activity corresponding to the behavior.

77. The system of claim 74, wherein the first study spans a first period of time and the second study spans a second period of time different from the first period of time.

78. The system of claim 77, wherein the processor is operative to select participants who carried out the identified characteristic within the period of time of the study measuring the activity corresponding to the characteristic.

79. The system of claim 77, wherein the processor is operative to weight data representative of the identified behavior of the selected participants based upon the period of time of the study measuring the activity corresponding to the behavior.

80. The system of claim 77, wherein the processor is operative to apply, to the identified behavior of each of the selected participants, a respective single weight to compensate for different levels of compliance of the participants included in the report over the period of time of the study measuring the activity corresponding to the behavior.

81. A system for producing a report from datasets containing data representative of results of studies measuring different activity, comprising:
at least one input for receiving data from a plurality of datasets each including data representative of activity of participants in a respective study;
the at least one input receiving an identified characteristic for use in generating a report; and
a processor coupled to the at least one input and operative to:
select a first dataset from the plurality of datasets measuring activity of participants in the respective study corresponding to the identified characteristic for use in generating the report;
select for inclusion in the report participants in the selected first dataset who, as indicated by the data of the first selected dataset, carried out the identified characteristic;
identify a behavior to integrate with the identified characteristic;
select a second dataset from the plurality of datasets measuring activity of participants in the respective study corresponding to the identified behavior, the participants in the study corresponding to the selected first dataset also being participants in the study corresponding to the selected second dataset; and
produce a report including data representative of the participants selected for inclusion in the report and data representative of the activity of the participants selected for inclusion measured in the study corresponding to the selected second dataset.

82. The system of claim 81, wherein the processor is operative to weight the data representative of the activity measured in the study corresponding to the second selected dataset based upon a period of time of the study corresponding to the second selected dataset.

83. The system of claim 81, wherein the selected second dataset includes data representative of measured activity of participants resulting from at least two measures pertaining to the activity; the processor being operative to apply, to the measured activity of each of the participants, a respective single weight to compensate for different levels of compliance of the participants corresponding to the at least two measures.

84. The system of claim 83, wherein the single weight applied to the measured activity of each of the participants is a function of an inverse of a combination of levels of compliance of the respective participant corresponding to the at least two measures.

85. A system for weighting a dataset containing data representative of results of a study measuring activity of a plurality of participants, comprising:
at least one input for receiving a dataset containing data representative of results of a study measuring activity of a plurality of participants;
the at least one input receiving a designated behavior; and
a processor coupled to the at least one input and operative to:
produce, for each of the participants, a single weighting factor based upon a total period of time of the study measuring the activity corresponding to the designated behavior; and
weight the data representative of the measured activity of each of the participants in accordance with the respective single weighting factor.

86. The system of claim 85, wherein the processor is operative to ascertain, for each of the participants, the single weighting factor to compensate for different levels of compliance of the participants over the total period of time of the study.
